(19) United States
(12) Patent Application Publication
(10) Pub. No.: US 2011/0030834 A1
(43) Pub. Date: Feb. 10, 2011

(54) MULTI-LAYERED CORRUGATED TUBULAR ARTICLE

(75) Inventor: John Peter Booth, Yorkshire (GB)

Correspondence Address: Monument IP Law Group, 1717 Pennsylvania Avenue, Suite 900, Washington, DC, 20006, US

(73) Assignee: ITI SCOTLAND LIMITED, GLASGOW (GB)

(21) Appl. No.: 12/919,262

(22) PCT Filed: Feb. 25, 2009
(86) PCT No.: PCT/GB09/50192

§ 371 Date: Oct. 19, 2010

(30) Foreign Application Priority Data
Feb. 25, 2008 (GB) 0803361.5

(51) Int. Cl. F16L 9/16; B32B 3/28; B32B 1/08; B21F 3/02

(52) U.S. Cl. 138/154; 428/184; 428/186; 72/135

(57) ABSTRACT

The present invention provides a multi-layered corrugated cylindrical tubular structure formed from a strip (10) of material having one edge reduced in diameter by a step portion (16) and reduced in length by corrugations (18). The strip may be formed on a forming arrangement comprising confronting corrugating rollers (74, 76) having regions formed with corrugating undulations of differing height and an un-corrugated portion.

### CROSS-REFERENCE TO RELATED APPLICATIONS

This application is a United States national phase application under 35 U.S.C. §371 of International Patent Application No. PCT/GB2009/050192 filed on Feb. 25, 2009, which was published as International Publication No. WO 2009/106888 A1 on Sep. 3, 2009, and claims the benefit of Great Britain Patent Application No. 0803361.5, filed on Feb. 25, 2008, both of which are incorporated by reference herein in their entirety.

### FIELD

The present invention relates to tubular articles and relates particularly, but not exclusively, to tubular articles having a partially corrugated structure, to a strip for use in the manufacture of such a structure, a means for creating said strip and a method of manufacturing such a structure.

### BACKGROUND

GB 2280889 discloses a tubular article formed from a strip of metal wherein the strip comprises a length of metal formed having a width W and length L and comprising two or more longitudinally extending portions and one or more longitudinally extending step portions therebetween. In practice, a tubular article is formed by winding the strip in a spiralling self-overlapping relationship such that the strip is deposited onto an earlier deposited strip portion to form a multi-layered tubular article. To aid manufacture the strip is pre-curved to a selected diameter the same as or slightly smaller than that required in the finished article such that the strip naturally tends towards the required diameter and the use of an adhesive to retain the strip in its final form is reduced and possibly eliminated. It is also known to cause the strip to curve along its length by thinning one edge of said strip relative to the other edge thereof. Such thinning may be achieved by passing the desired edge between forming rollers set to pinch or squash the desired edge and, thereby, to lengthen said edge as the strip passes therebetween. Whilst this process lends itself well to use on ductile materials, such as aluminium, copper and low tensile steel, it does not lend itself to use on more brittle materials or materials, such as high strength Martensitic steel, which can be prone to cracking when subjected to such stress. Additionally, it will be appreciated that the thinning must be progressive across the strip, which is difficult to achieve and control.

One possible solution to the above-mentioned problem is disclosed in U.S. Pat. No. 6,732,906 to Andersen, entitled “Tapered Tower Manufacturing Method and Apparatus, which provides a strip of metal for producing tapered towers wherein the strip is provided with a series of corrugations across its width W, the height H of which varies progressively between a maximum at one end and zero at another. In use, a tapered tower is produced by wrapping the strip in a spiral manner such that the corrugated portions abut up against each other and a tapered tubular article is formed having a serrated inner and outer surface formed by the protruding edges of the strip. The corrugated edge lies against a straight edge and must be joined thereto by welding which can be problematic. This arrangement is unable to provide a consistent thickness of material across the wall structure and the structure will, therefore, have differing strengths at different portions of the structure. Additionally, the structure is tapered and would not, therefore, lend itself to use in the manufacture of pipes and the like which should be substantially parallel sided, of even wall thickness and devoid of surface perturbations.

It is an object of some embodiments of the present invention, among other things, to provide a tubular article, which reduces and possibly overcomes the problems of the above-mentioned prior art whilst also providing a strip for use in the manufacture of such a structure, a means for creating such a strip and a method of manufacturing such a structure.

### SUMMARY

Accordingly, the embodiments of the present invention provide a tubular article comprising one or more strips of self-overlapping helically wound strip material having a width W and length L and comprising two or more longitudinally extending portions and one or more longitudinally extending step portions therebetween. At least two adjacent longitudinally extending portions may include a plurality of corrugations extending in the width W direction of the strip, wherein the height Hc of the corrugations of the corrugated portion at an outer diameter is less than the height Hc of the corrugations of the corrugated portion at an inner diameter Di. According, the strip is curved towards the corrugated portion at the inner diameter side Di thereof.

Preferably, in some embodiments, the strip includes an un-corrugated longitudinally extending portion adjacent the corrugated portion at the outer diameter and having at an outer diameter Do, which is greater than the corrugated portion at said outer diameter.

In some embodiments, the article may preferably comprise a plurality of longitudinally extending portions having corresponding step portions therebetween. In these preferred arrangements, the corrugations are of substantially constant height Hc within each corrugated longitudinally extending portion. The width Wfp of each longitudinally extending portion may be preferably substantially the same as the width of an associated radially adjacent portion.

The height Hs of a step portion may be preferably equal to or greater than the height Hc of the corrugations in a radially adjacent longitudinally extending portion. In some applications it may be desirable to provide an inner liner, which is resistant to corrosion, abrasion or pressure. In order to produce a product with a relatively smooth outer surface, the outer diameter portion may be non-corrugated.

The strip is curved towards a corrugated side thereof such as to provide the strip with a natural curve broadly corresponding to the helix angle of the strip as it is formed into a pipe. Such an arrangement assists with the laying down of the strip whilst coiling to the final diameter.

According to a second aspect of the present invention, there is provided a strip suitable for forming into a helically wound tubular structure as described above wherein said strip comprises a strip of material having a width W and length L and comprising two or more longitudinally extending portions and one or more longitudinally extending step portions therebetween. At least two adjacent longitudinally extending portions may include a plurality of corrugations extending in the width W direction of the strip, wherein the height Hc of said corrugations of a first longitudinally extending portion is greater than the height Hc of the corrugations of an adjacent second longitudinally extending portion such that said strip is curved towards the first longitudinally extending portion thereof.

Preferably, in some embodiments, the strip includes an un-corrugated longitudinally extending portion adjacent the second longitudinally extending portion and wherein the first longitudinally extending portion is at a first, lower, height H1 and the un-corrugated longitudinally extending portion is at a second, greater, height H2.

Preferably, in some embodiments, the strip comprises a plurality of longitudinally extending portions having corresponding step portions therebetween. Preferably, the corrugations are of substantially constant height Hc within each longitudinally extending portion and each longitudinally extending portion has a width Wfp, which is substantially the same as the width of an associated radially adjacent portion.

Preferably, the height Hs of a step portion may be equal to or greater than the height Hc of the corrugations in a radially adjacent longitudinally extending portion.

If it is desirable to have a finished article with a relatively smooth outer surface, then the outer diameter portion may be non-corrugated.

According to a still further aspect of the present invention, there is provided a corrugating mechanism comprising spaced apart confronting rollers, each roller having two or more axially adjacent axially extending portions having rolling surfaces and being mounted for rotation about a axially extending parallel axes X1, X2, said axially adjacent axially extending portions being stepped to form tapered confronting rollers tapering in opposite directions such as to create a longitudinally extending step along the length of a strip passed therethrough at a junction of adjacent longitudinally extending portions of said strip, wherein at least two pairs of mutually confronting rolling surfaces are corrugated in anti-phase with each other, and the corrugation height Hc of a first pair of mutually confronting rolling surfaces is greater than the corrugation height Hc of a second adjacent pair of mutually confronting rolling surfaces, thereby to corrugate strip material having a width W and length L passing therebetween such that said strip material forms two or more longitudinally extending portions and one or more longitudinally extending step portions therebetween, characterised in that at least two adjacent said longitudinally extending portions include a plurality of corrugations extending in the width W direction of the strip, wherein the height Hc of said corrugations of a first longitudinally extending portion is greater than the height Hc of the corrugations of an adjacent second longitudinally extending portion and wherein the strip is curved towards the first longitudinally extending portion thereof.

Advantageously, one or more pairs of the mutually confronting rolling surfaces are non-corrugated, and the rollers are spaced apart at a distance D equal to or less than the thickness t of a strip of material to be passed therethrough, thereby to hold or clamp the material as it passes therethrough. In an arrangement of convenience, the rollers each have three or more axially extending portions one of which is un-corrugated and the remaining portions of which are corrugated.

The mechanism may also comprise a driving mechanism for driving one or both of the rollers, thereby to feed a strip therethrough and, preferably, one of the rollers has a smaller average diameter than the other, thereby to cause a strip being passed therethrough to curve to a diameter. Preferably still, this diameter is smaller than that required in the finished tubular article. Preferably, the axial lengths L1, L2, L3 of each of the axially extending portions are substantially the same as each other, thereby to allow the strip to more easily lie on top of an immediately adjacent layer.

The present invention also provides a method of corrugating a strip comprising the steps of: providing a pair of spaced apart confronting rollers, each roller having two or more axially adjacent axially extending portions having rolling surfaces having corrugated portions with heights that differ between the portions and being mounted for rotation about a axially extending parallel axes X1, X2, the axially adjacent axially extending portions being stepped to form tapered confronting rollers tapering in opposite directions such as to create a longitudinally extending step along the length of the strip at a junction of adjacent longitudinally extending portions of the strip, wherein at least two pairs of mutually confronting rolling surfaces have corrugations in anti-phase with each other and the corrugation height Hc of a first pair of rolling surfaces is greater than the corrugation height Hc of a second adjacent pair of rolling surfaces; driving a strip of material through a gap G between the rolling surfaces, to corrugate at least two longitudinally extending portions of the strip such that the corrugation height Hc of the corrugations on a first longitudinally extending portion if the strip is greater than the corrugation height Hc of a second adjacent longitudinally extending portion of the strip. The method may include the step of passing the strip between step tapered rollers, the rollers being tapered in opposite directions such as to create a longitudinally extending step along the length of the strip at a junction of adjacent longitudinally extending portions of the strip and wherein the strip is curved towards the first longitudinally extending portion thereof.

Advantageously, the method may include the step of passing the strip between rollers of different diameters, thereby to curve the strip to a desired radius of curvature and the further step of winding the strip onto itself in self-overlapping relationship, thereby to form a multi-layered tubular structure having inner strip portions over-wound by subsequently deposited outer strip portions.

### BRIEF DESCRIPTION OF THE DRAWINGS

The present invention will now be more particularly described by way of example only, in which:

FIG. 1 is a cross-sectional view of a first form of strip material according to one aspect of the present invention and used to form a tubular structure according to another aspect of the present invention;

FIG. 2 is a general isometric view of a tubular article according to an aspect of the present invention;

FIG. 3 is a cross-sectional view of the structure of FIG. 2 taken in the direction of arrows A-A;

FIG. 4 is an exploded partial view of a portion of the structure shown in FIG. 2 and illustrates the difference in the height of the corrugations between radially adjacent layers with some layers omitted for the purposes of clarity;

FIG. 5 is an exploded view of an alternative portion of the structure shown in FIG. 2 and illustrates the position of a liner;

FIG. 6 is an exploded and linearised view of a portion of the structure of FIG. 2 and illustrates the corrugations in more detail;

FIG. 7 is a general view of an apparatus for manufacturing the strip of FIG. 1 or the tubular article of FIG. 2 and includes a rolling station;

FIG. 8 is a plan view of two rollers that form the rolling station of FIG. 7;

FIG. 9 is a first isometric view of the rollers of FIGS. 7 and 8;

FIG. 10 is a second isometric view of the rollers of FIGS. 7 to 9 and illustrates a strip of material passing therebetween;

FIG. 11 is a plan view of the strip material of FIG. 10; and

FIGS. 12 to 14 are illustrative of how the corrugations interlock during internal pressure loading and illustrate corrugations arranged at an angle other than perpendicular to the edge of the strip.

### DETAILED DESCRIPTION OF EMBODIMENTS OF THE INVENTION

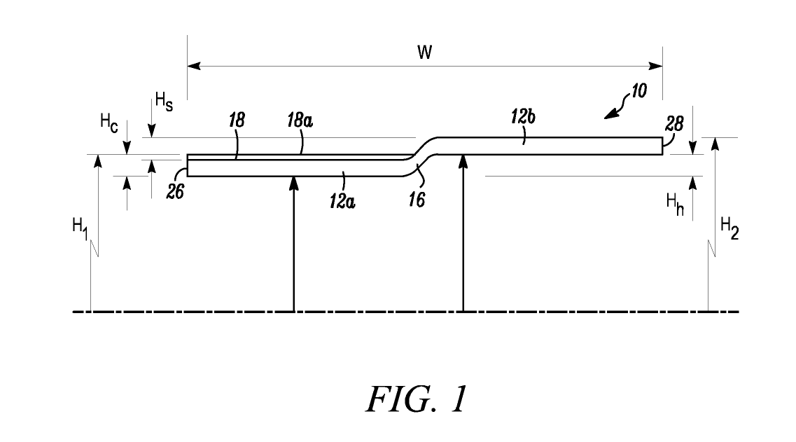

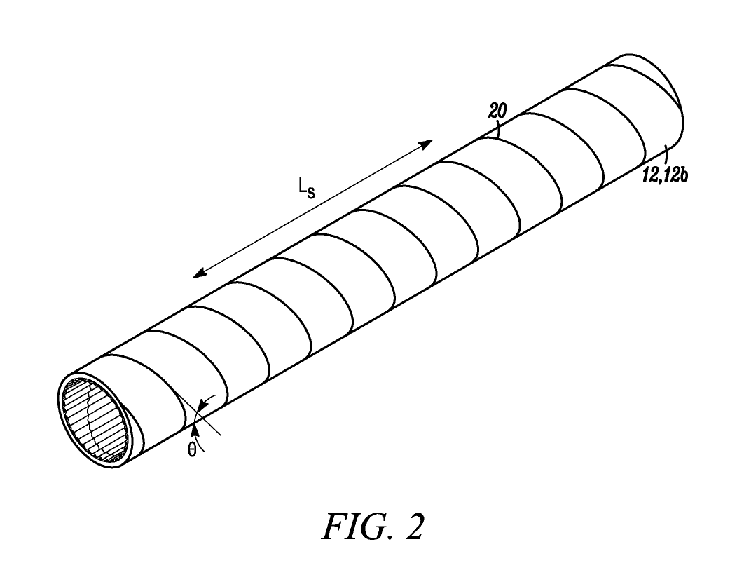

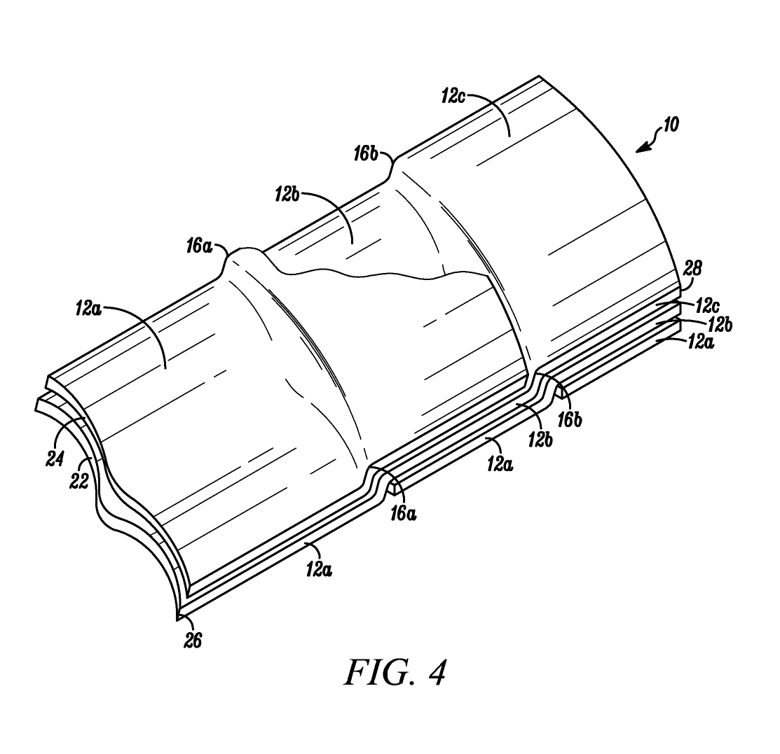

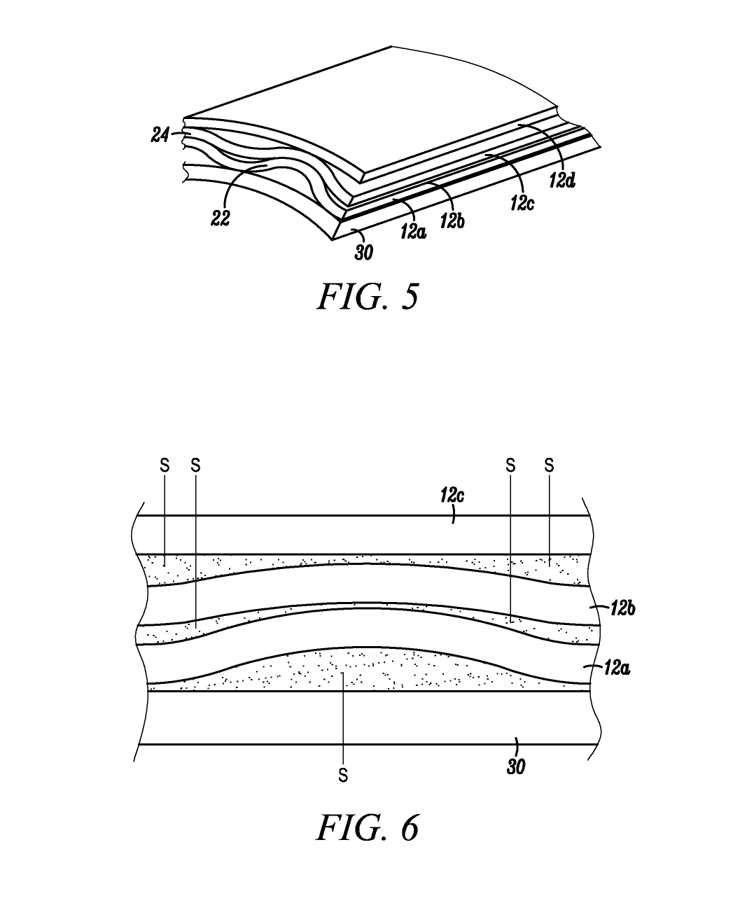

Referring now to the drawings in general, but particularly to FIGS. 1 and 2, a strip of material 10 processed in accordance with the present invention and suitable for forming into a helically wound tubular structure of FIG. 2 comprises a material such as a metal having a width W and length L (not shown) and comprising two or more longitudinally extending portions 12a, 12b and one or more longitudinally extending step portions 16 therebetween. One of the portions 12a includes a plurality of corrugations 18 extending across the width W thereof, the function of which will be described in more detail later herein. Of particular note in FIG. 1 is the height Hc of the corrugation and the height Hs of the step, which is selected such as to allow the corrugation of a radially adjacent portion to be housed within the height Hh formed under the step 16 itself. The corrugations of a radially inward portion are shown in outline at 18a by way of illustrating this arrangement but the reader's attention is drawn more particularly to FIGS. 4 and 5, which show the relationship in more detail. It will be appreciated that the corrugated portion is at a first, lower, height H1 and the other longitudinally extending portion is at a second, greater, height H2 and is un-corrugated. FIG. 2 simply illustrates a tubular article 20 formed by winding the strip of FIG. 1 in self-overlapping relationship in the manner described later herein.

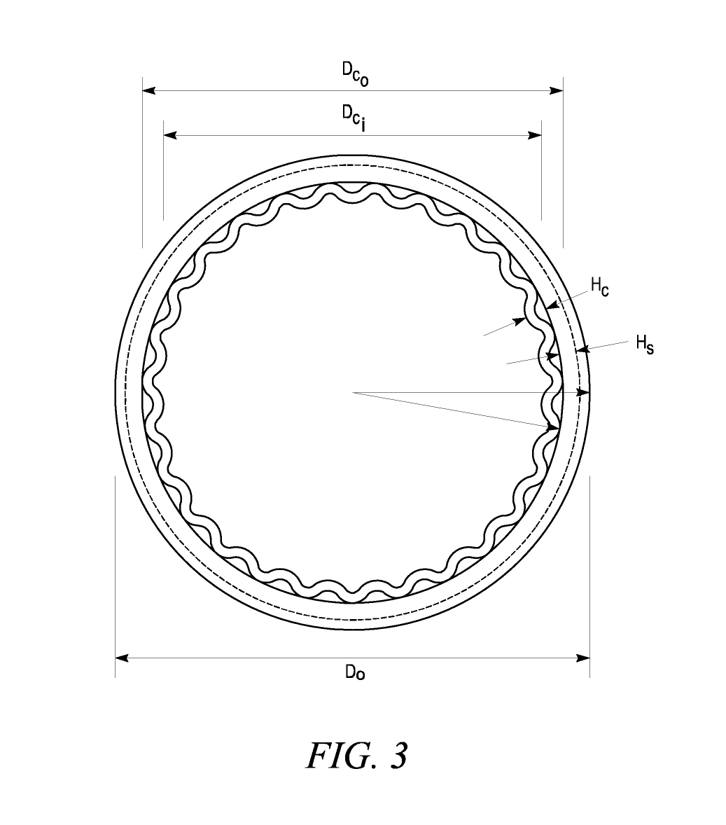

FIG. 3 is a cross-sectional view of FIG. 2 and illustrates the relationship between the corrugations of one layer and the un-corrugated adjacent layer. It may be noted that the total height Hc of the corrugations is substantially the same as or less than the height Hs of the step of the adjacent non-corrugated portion 12b.

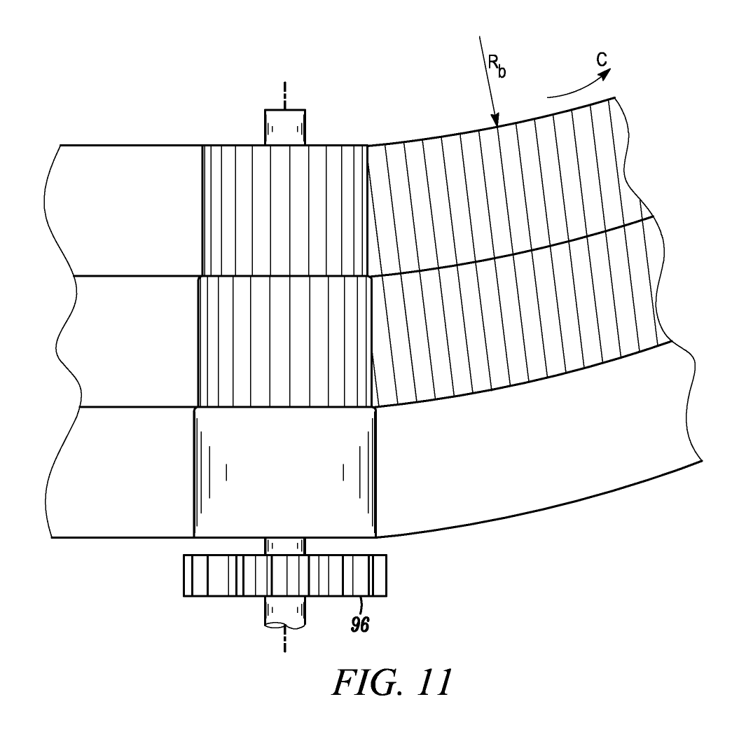

FIG. 4 provides further detail than can be shown in FIG. 3 and illustrates the arrangement having three longitudinally extending portions 12a, 12b and 12c. Each portion 12 is associated with a corresponding step portions 16a and 16b therebetween and two of the portions are corrugated as shown at the end and referenced 22 and 24. It will be appreciated that the two steps of this arrangement may be replaced by three or more steps in the event that a stronger structure is required. Each step provides a void for receiving a radially adjacent corresponding portion 12 formed by an adjacent level on a preceding winding of the strip 10, and allows for the production of a multi-layered tubular structure having a consistent number of layers at any point along its length Ls. The widths W of each portion 12a, 12b, 12c etc are substantially the same so as to allow one portion to nestle within the void defined by its immediately adjacent radial neighbour. As shown in FIGS. 1 and 4, the corrugations are of substantially constant height Hc within each longitudinally extending portion. It is this feature which allows the present invention to accommodate the difference in diameter between the inner layer and the outer layer once wound into the final form, as shown in FIG. 2. In effect, the corrugated side is shortened due to the collecting up of the material at the edge thereof which effectively shortens the edge whilst increasing the height at any corrugated position. This corrugating can be done by a roller mechanism as shown later herein and imparts little if any stress into the material and certainly does not stretch the material to any significant degree. By avoiding stretching one is able to avoid the cracking and stressing problems of the prior art, which thin one side of the strip in order to accommodate the difference in diameter between the inner edge and an outer edge. This is also in stark contrast with the alternative prior art arrangement in which the corrugations taper between one side of the strip and another. The height Hc of the corrugations varies between portions 12a and 12b and the outer corrugations have less height Hc than inner corrugations. This effectively steps the reduction of edge diameter between an inner edge 26 and an outer edge 28 and causes the strip 10 to adopt a curved profile, bending in the direction of arrow C towards the corrugated side as best seen in FIG. 10. The radius of curvature Rc is dictated by the severity of the corrugations and may be selected to impart a given curvature corresponding to the angle 8 of the strip lay-down, otherwise known as the helix angle. It will also be appreciated that the degree of deformation is relatively low and that the corrugations are blended into the portion of material forming the steps 16a, 16b so as to provide a smooth transition therebetween and avoid areas of possible stress concentration.

FIG. 5 illustrates the above arrangement when provided as a three layer construction together with a liner as shown at 30. Such liners are well known in the art and may comprise a more ductile metal such as mild steel, aluminium or copper or may comprise a Stainless Steel or plastics material, which forms an anti-corrosive liner.

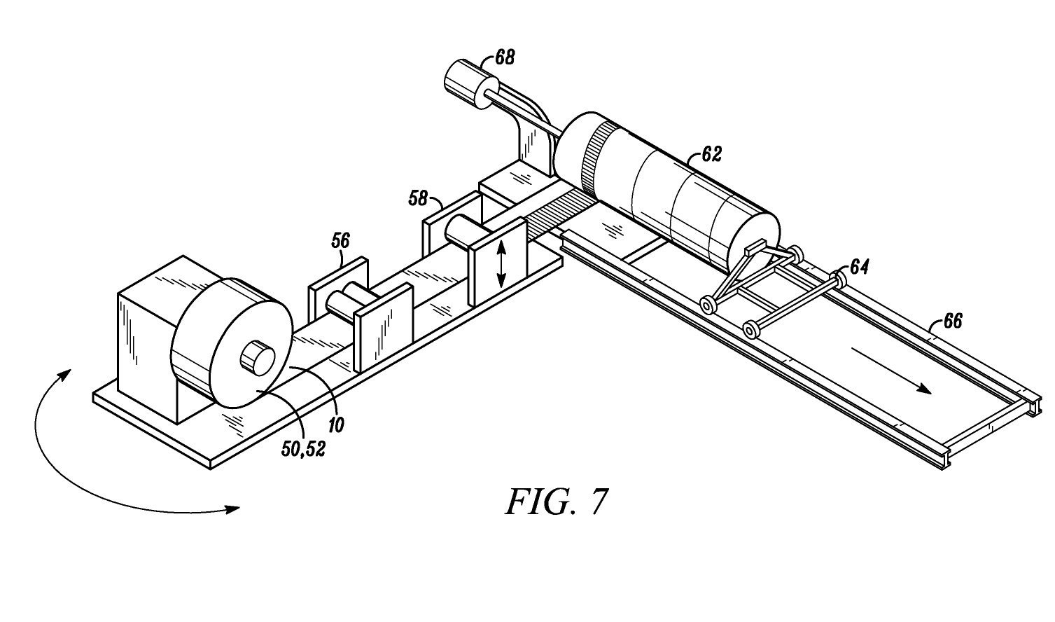

FIG. 6 illustrates the corrugation arrangement in much more detail and from which it can be seen how the corrugations inter-engage once the strip has been wound into a multi-layered structure. In this arrangement, the inner liner 30 is a simple single layered arrangement having no corrugation associated therewith whilst the next two layers 12a, 12b are corrugated to different degrees, as explained above, and nestle one within the other as shown. This nestling creates a good degree of location and helps prevent slipping of the strips once wound and also helps location of the strip during winding. The spaces S between the corrugations may be filled with an adhesive 32 so as to further secure the strip material. This adhesive may be a load carrying adhesive such as Araldite™ or the like such as to allow any internal pressure from within a finished tubular article 20 to be reacted both through the strip 10 and the adhesive itself.

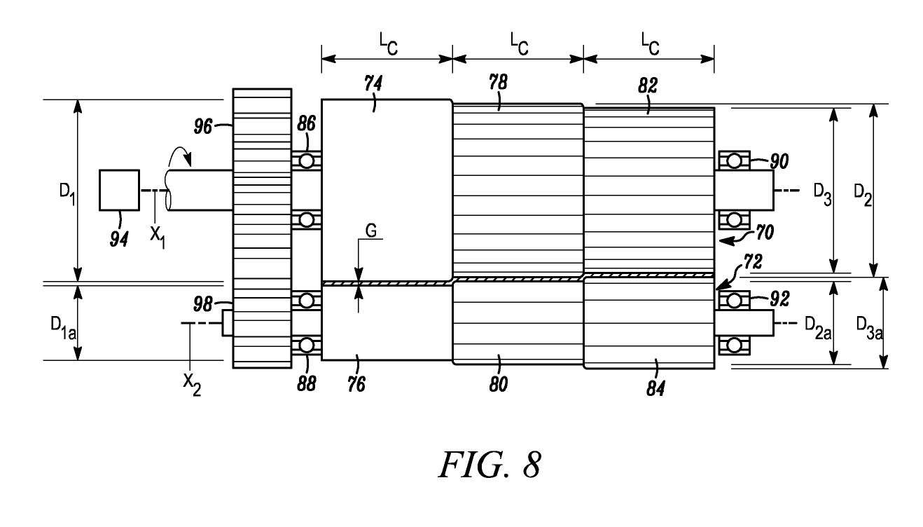

Referring now to FIG. 7 which illustrates a possible apparatus for manufacturing the strip 10 or final tubular article 20, it will be appreciated that a coil of flat strip 50 may be supplied form a bobbin or cassette thereof, shown at 52 and fed by means of a power driving mechanism shown schematically at 54. The strip 10 may be passed through a flattening station 56 before entering a roller section 58 at which point it is corrugated as described above and as shown in more detail in the following Figures. Once corrugated, the strip 12 may be wound onto a cassette 60 (not shown) or formed directly into a tubular article 20 as discussed in detail above. The forming process is well known in the art and comprises laying down or winding of the strip 10 in self-overlapping manner such that inner portions 12a are overlain by intermediate portions 12b which, in turn, are overlain by the outer smooth portion 12c (best seen in FIGS. 4 and 5). When manufacturing a tubular article, it may be possible to move the article itself during the winding process and thus form relatively short sections of pipe, as shown generally at 62. To this end, a movable trolley support 64 may be provided on a track 66 and may be driven to rotate and translate by means of a driving mechanism shown generally and schematically at 68. Alternatively, the corrugating station 58 may be provided on a rotating winding head (not shown) which moves around the tubular article as it is translated therethrough, thereby to wind the strip onto itself in self-overlapping relationship and form the article. Such mechanisms are well known in the art and, therefore, not described in detail herein.

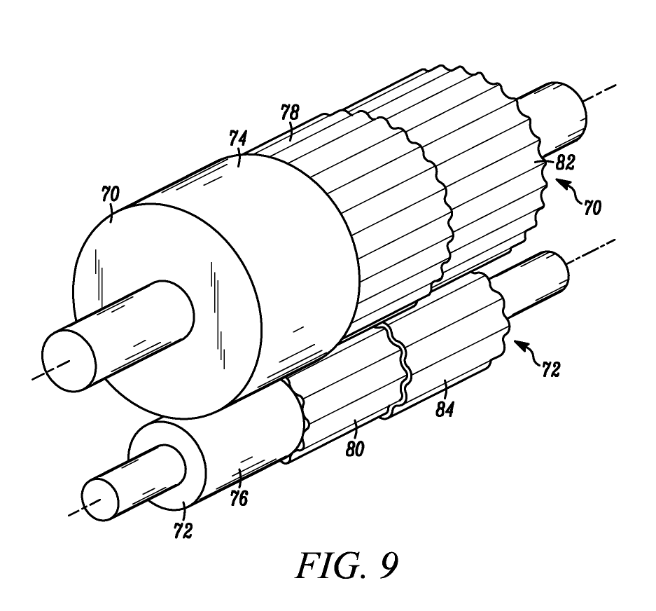

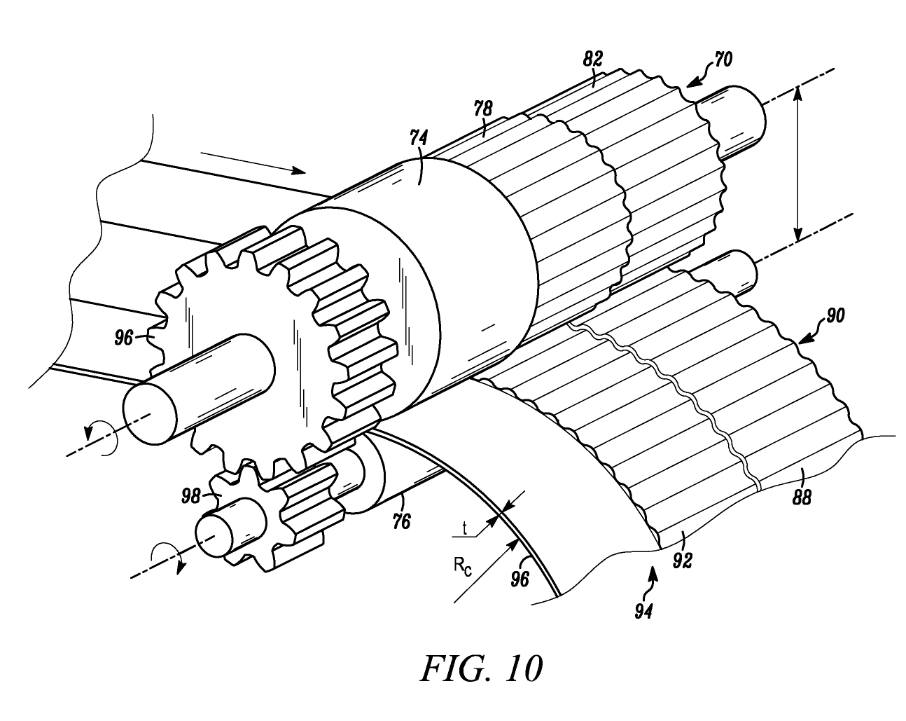

FIGS. 8 and 9 illustrate the corrugating station of FIG. 7 and include first and second corrugating rollers 70 and 72 arranged to rotate on parallel spaced apart axes X1 and X2. Each roller comprises a stepped tapered roller having distinct portions 74 to 84 of substantially the same axial length Lc but different diameter D1, D1a, D2, D2a, D3 and D3a. A small gap G is defined between the respective portions of the rollers, the function of which will be described in detail later herein. Each roller 70, 72 is mounted for rotation in bearings shown at 86 to 92 and one or other of the rollers is driven by means of a motor shown schematically at 94. An intermeshing gearing arrangement 96, 98 (also shown in FIG. 10) allows for the transfer of drive between the rollers and ensures an even speed of rotation. The gap G can be selected to correspond to the thickness t of any strip material to be fed between the rollers such as to allow non-corrugated portions 74, 76 to grip the strip without working the material itself. The remaining portions 78 to 84 are each corrugated and the corrugations are aligned such as to allow the peaks of one corrugation on one roller to coincide with the troughs of the corrugations provided on the confronting surfaces of a corresponding portion of the opposite roller whilst still maintaining a gap G therebetween. As mentioned above with reference to FIGS. 1 to 6, the corrugations are progressive along the strip and this is done by varying the height Hc of the corrugations on each of the roller portions 78 to 84, the actual height of any corrugation on any one portion remaining substantially the same along its length Lc.

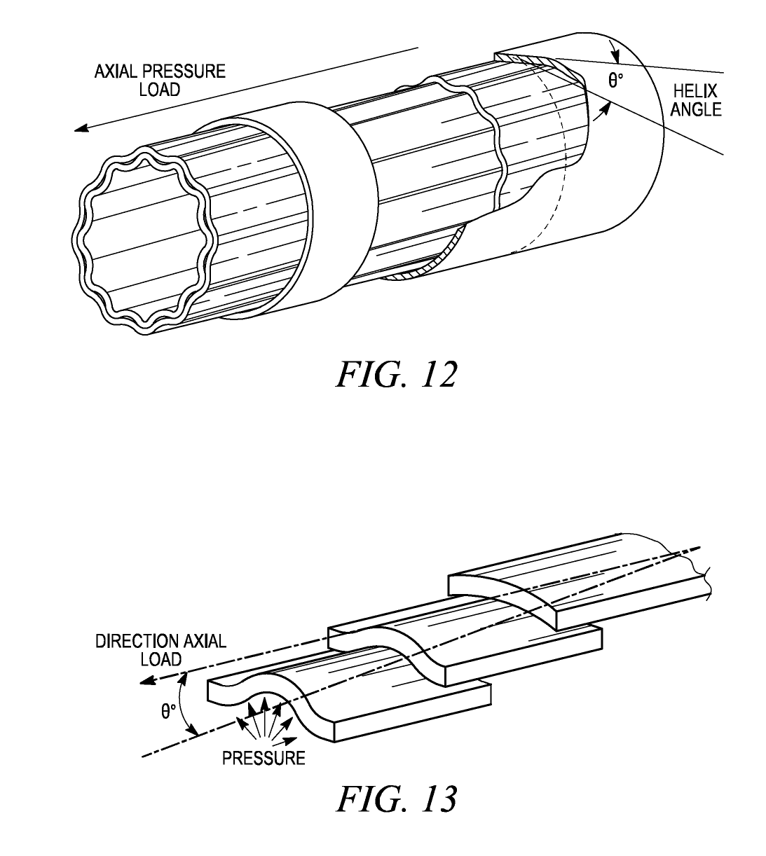

The operation of the corrugating station may be best appreciated with reference to FIGS. 10 and 11 from which it will be appreciated that the strip of metal 10 is passed between the rollers such as to cause the inter-meshing corrugated portions 78 to 84 to deform the metal strip such as to form the corrugations described above with reference to FIGS. 8 and 9. This deformation is progressive in the sense that the height of corrugations 88 on the corrugated edge section 90 is greater than the height of the corrugations 92 in the mid section 94 and no corrugations are provided on the other edge section 96. By this action one will form the corrugated strip shown above where the 12a to 12c correspond to sections 90, 94 and 96. This corrugating arrangement effectively shortens one edge 90 whilst maintaining the other edge 96 at its pre-deformed length. The result of this action is best illustrated in FIG. 11, from which it will be appreciated that the strip 10 will take a curve of radius Rb bending towards to most corrugated portion. This curvature allows the strip to sit correctly relative to its required diameter and nestle easily within the corrugated profile of its radially adjacent neighbour in order to create a closely packed multi-layer structure as described above. The strip can be caused to bend to a pre-defined radius of curvature Rc by providing rollers of different diameters, as shown. In this particular arrangement the diameter of curvature Rc will be the average of the diameters of the two adjacent rollers and may be employed to great advantage as if the radius of curvature Rc is selected to be slightly less than that desired for the finished tubular structure then the structure will cling to the portion of strip previously deposited in a self-supporting manner and cause some compressive forces to be transmitted downwardly into the structure 20 or any liner placed therein. This may be of assistance when attempting to counteract internal pressures that may be experienced by the structure itself.

It will be appreciated that the above-described strip, tubular article and method of manufacturing provides a number of advantages over the prior art. In particular, for example, the strip itself 10 is provided with an reduced inner diameter when curved into a tubular article whilst avoiding the problem associated with the prior art which must cold work the outer edge of the strip and which may result in adverse mechanical properties and may result in premature failure. Secondly, the final tubular article itself 20 can be more easily formed and under less working stress which may well result in an improved working lifetime and reduced failure rates. Thirdly, the corrugating mechanism is able to corrugate the strip without over stressing the material and the corrugating profile is such as to allow the corrugations of the strip to nestle or lie one within the other, thereby assisting with strip lay down and strip security and accuracy of location once the tubular article is formed. The strip may be pre-formed in the factory and loaded onto a carrying or shipping cassette or may be manufactured in the field where it may be made alongside an apparatus making short sections of pipes or produced on a winding head rotating about a central axis such as to produce a continuous or semi-continuous tubular article or pipe. Such pipes may be used in multiple applications including the oil and gas industry, communications industry and in the supply of utilities.

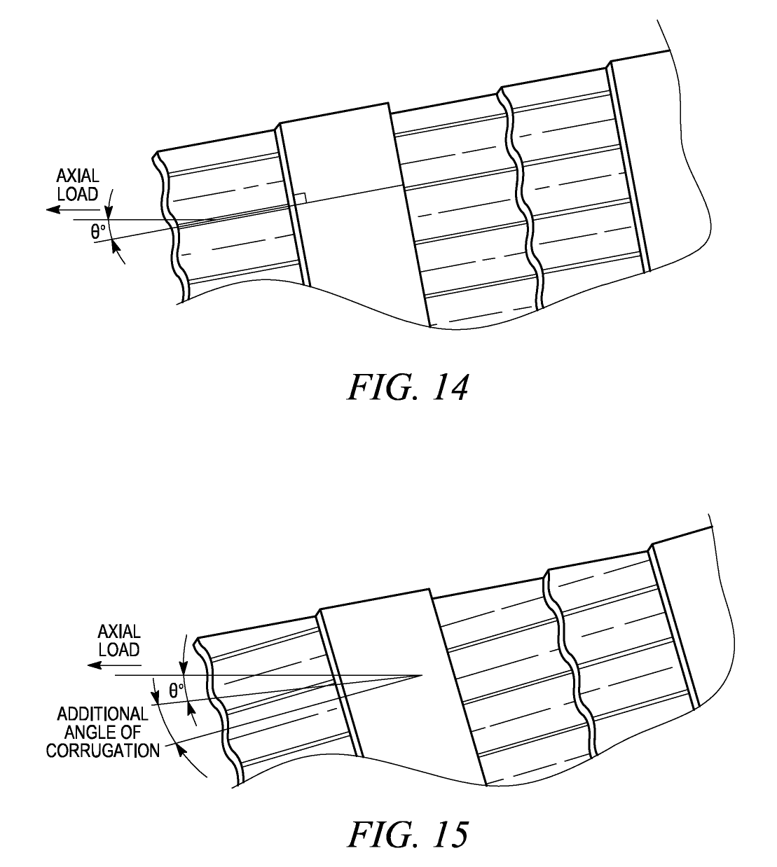

Reference is now made to FIGS. 12 to 15 from which one may see that the corrugations can nest together and that each step of the strip has the same amount of material per revolution. Even if the corrugations in the strip are at right angles to the longitudinal strip edge, when the strip is helically wound the orientation of the corrugations is at the helix angle. The principal axial stress always acts on the longitudinal axis of the pipe and 90 deg to the end cap. So if one applies internal pressure to the pipe, the frictional contact between the corrugated portions of each strip section will increase, but the corrugations angled obliquely to the principal axial load will also tighten up and lock. All strip sections will radially strain at the same rate under internal pressure and each convolution region of the strip has the same amount of material and will lock up by a wedge action. It will also be appreciated that the corrugations can be roll formed across the strip not at 90 deg but some greater oblique angle 8, which may offer more resistance to pull out.

While the invention has been described in detail and with reference to specific examples thereof, it will be apparent to one skilled in the art that various changes and modifications can be made therein without departing from the spirit and scope thereof.

1. A tubular article comprising one or more strips of self-overlapping helically wound strip material having a width W and length L and comprising two or more longitudinally extending potions and one or more longitudinally extending step portions therebetween, wherein one or more of said portions includes a plurality of corrugations extending across the width W thereof.

2. A tubular article as claimed in claim 1 wherein said corrugated portion is at a first, inner, diameter Di and said other longitudinally extending portion is at an outer diameter Do and is un-corrugated.

3. A tubular article as claimed in claim 1 or claim 2 wherein said article comprises a plurality of longitudinally extending portions having corresponding step portions therebetween, two or more of which are corrugated.

4. A tubular article as claimed in any one of claims 1 to 3 wherein said corrugations are of substantially constant height Hc within each longitudinally extending portion.

5. A tubular article as claimed in claim 4 wherein the width W_{fp} of each longitudinally extending portion is substantially the same as the width of an associated radially adjacent portion.

6. A tubular article as claimed in any one of claims 2 to 5 wherein the height Hc of the corrugations varies between adjacent corrugated portions.

7. A tubular article as claimed in claim 6 wherein said height Hc increases between portions at an outer diameter Do and an inner diameter Di.

8. A tubular article as claimed in claim 7 wherein the height Hs of a step portion is equal to or greater than the height Hc of the corrugations in a radially adjacent longitudinally extending portion.

9. A tubular article as claimed in any one of claims 2 to 8 wherein said article further includes a liner portion within said tubular structure.

10. A tubular article as claimed in any one of claims 1 to 10 wherein the outer diameter portion is non-corrugated.

11. A tubular article as claimed in any one of the previous claims wherein said strip is curved towards a corrugated side thereof.

12. A strip suitable for forming into a helically wound tubular structure according to any one of claims 1 to 11 wherein said strip comprises a strip of material having a width W and length L and comprising two or more longitudinally extending potions and one or more longitudinally extending step portions therebetween, wherein one or more of said portions includes a plurality of corrugations extending across the width W thereof.

13. A strip as claimed in claim 12 wherein said corrugated portion is at a first, lower, height H1 and said other longitudinally extending portion is at a second, greater, height H2 and is un-corrugated.

14. A strip as claimed in claim 12 or claim 13 wherein said strip comprises a plurality of longitudinally extending portions having corresponding step portions therebetween, two or more of which are corrugated.

15. A strip as claimed in any one of claims 12 to 14 wherein said corrugations are of substantially constant height Hc within each longitudinally extending portion.

16. A strip as claimed in claim 15 wherein each longitudinally extending portion has a width W_{fp} and said is substantially the same as the width of an associated radially adjacent portion.

17. A strip as claimed in any one of claims 13 to 16 wherein the height Hc of the corrugations varies between adjacent corrugated portions.

18. A strip as claimed in claim 17 wherein said height Hc increases between portions at an outer diameter Do and an inner diameter Di.

19. A strip as claimed in claim 18 wherein the height Hs of a step portion is equal to or greater than the height Hc of the corrugations in a radially adjacent longitudinally extending portion.

20. A strip as claimed in any one of claims 13 to 19 wherein said article further includes a liner portion within said tubular structure.

21. A strip as claimed in any one of claims 13 to 20 wherein the outer diameter portion is non-corrugated.

22. A strip as claimed in any one of claims 12 to 21 wherein said strip is curved towards a corrugated side thereof.

23. A corrugating mechanism comprising spaced apart confronting rollers, each roller having two or more axially adjacent axially extending portions having rolling surfaces and being mounted for rotation about a longitudinally extending parallel axes X1, X2, wherein one or more pairs of mutually confronting rolling surfaces are corrugated in anti-phase with each other, thereby to corrugate any material passing therebetween and wherein the height Hc of each corrugation increases between immediately adjacent axially extending portions.

24. A corrugating mechanism as claimed in claim 23, wherein one or more pairs of said mutually confronting rolling surfaces are non-corrugated, and said rollers are spaced apart at a distance D equal to or less than the thickness t of a strip of material to be passed therethrough, thereby to hold or clamp said material as it passes therethrough.

25. A corrugating mechanism as claimed in claim 23 or 24, wherein said rollers comprise step tapered rollers tapering in opposite directions such that an even or substantially even distance is maintained between the confronting surfaces of adjacent rollers.

26. A corrugating mechanism as claimed in any one of claims 23 to 25 wherein said rollers each have three or more axially extending portions one of which is un-corrugated and the remaining portions of which are corrugated.

27. A corrugating mechanism as claimed in any one of claims 23 to 26 and including a driving mechanism for driving one or both of said rollers, thereby to feed a strip therethrough.

28. A corrugating mechanism as claimed in any one of claims 23 to 27 wherein one of said rollers has a smaller average diameter than the other, thereby to cause a strip being passed therethrough to curve to a diameter.

29. A corrugation mechanism as claimed in any one of claims 23 to 28, wherein the axial lengths L1, L2, L3 of each of the axially extending portions are substantially the same as each other.

30. A method of corrugating a strip comprising the steps of:
i) providing a pair of spaced apart confronting rollers, each roller having two or more axially adjacent axially extending portions having rolling surfaces and being mounted for rotation about a longitudinally extending parallel axes X1, X2, wherein one or more pairs of mutually confronting rolling surfaces are corrugated in anti-phase with each other; and
ii) driving a strip of material through a gap G between said rollers, thereby to cause said corrugated portions to deform and corrugate at least a portion of said strip; and
iii) varying the corrugation height between adjacent corrugated portions.

31. A method as claimed in claim 30 including the step of passing said strip between step tapered rollers, said rollers being tapered in opposite directions such as to create a longitudinally extending step along the length of said strip at a junction of adjacent longitudinally extending portions of said strip.

32. A method as claimed in claim 31 including the step of forming the corrugations of a strip having multiple corrugated portions at different heights, the height of which increases between adjacent portions.

33. A method as claimed in any one of claims 30 to 32 including the step of passing the strip between rollers of different diameters, thereby to curve said strip to a desired radius of curvature.

34. A method as claimed in any one of claims 30 to 33 including the further step of winding said strip onto itself in self-overlapping relationship, thereby to form a multi-layered tubular structure having inner strip portions over-wound by subsequently deposited outer strip portions.
